(19) United States
(12) Patent Application Publication
(10) Pub. No.: US 2018/0197201 A1
(43) Pub. Date: Jul. 12, 2018

(54) NOTIFICATION PROVISIONING BASED ON LOCATION TRENDS OF GROUP MEMBERS WITHIN A VENUE

(71) Applicant: INTERNATIONAL BUSINESS MACHINES CORPORATION, Armonk, NY (US)

(72) Inventors: Lisa Seacat DeLUCA, Baltimore, MD (US); Jeremy A. GREENBERGER, Raleigh, NC (US)

(21) Appl. No.: 15/401,389

(22) Filed: Jan. 9, 2017

(51) Int. Cl. G06Q 30/02; H04W 4/02; H04W 4/08; H04W 68/02

(52) U.S. Cl. CPC G06Q 30/0261; H04W 4/02; H04W 4/08; G06Q 30/0255; G06Q 30/0204; G06Q 30/0267; H04W 68/02

(57) ABSTRACT

A computer-implemented process and system for notification provisioning based on location trends of group members within a venue are provided, which includes: identifying a group relationship between respective users of mobile devices within a venue; tracking movement of the mobile devices of the users in the group within the venue; and determining which mobile device of the mobile devices of the users in the group to send a notification to based, at least in part, on accumulated data associated with the users in the group, the accumulated data including movement data of the mobile devices of the users in the group within the venue.

### BACKGROUND

There are various conventional methods of predicting a user's interest in advertisements. For instance, a user's responses to one or more items or advertisements may be used in selecting future notifications or advertisements to send to the user. A user may have interest in a product or service, but a system can only record this fact if one or more items that can be used to predict this interest have been displayed or presented on, for instance, a user's mobile device, and the user has provided some detectable response to these items, such as selecting the item for further information, or purchasing the advertised product or service in a manner that records the purchase on the mobile device. The lack of information about such responses inhibits the system from predicting a user's level of interest, and thereby limits its ability to target advertising, and diminishes the effectiveness of such mobile advertising.

### SUMMARY

Certain shortcomings of the prior art are overcome and additional advantages are provided through the provision of a computer-implemented method which includes: identifying a group relationship between respective users of mobile devices within a venue; tracking movement of the mobile devices of the users in the group within the venue; and determining which mobile device of the mobile devices of the users in the group to send a notification to based, at least in part, on accumulated data associated with the users in the group, the accumulated data including movement data of the mobile devices of the users in the group within the venue.

In another aspect, a system is provided which includes a memory, and a processing unit communicatively coupled to the memory. The system performs a method, which includes: identifying a group relationship between respective users of mobile devices within a venue; tracking movement of the mobile devices of the users in the group within the venue; and determining which mobile device of the mobile devices of the users in the group to send a notification to based, at least in part, on accumulated data associated with the users in the group, the accumulated data including movement data of the mobile devices of the users in the group within the venue.

In a further aspect, a computer program product is provided for determining which mobile device of a group of users to send a notification to. The computer program product includes a computer readable storage medium having computer readable program code embodied therewith, which is executable by a processor to perform a method, including: identifying a group relationship between respective users of mobile devices within a venue; tracking movement of the mobile devices of the users in the group within the venue; and determining which mobile device of the mobile devices of the users in the group to send a notification to based, at least in part, on accumulated data associated with the users in the group, the accumulated data including movement data of the mobile devices of the users in the group within the venue.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 is a diagram of one embodiment of a venue where members of a group may receive a notification;

FIG. 2 depicts one embodiment of a notification provisioning process based on location trends of mobile devices of users in a group within a venue, in accordance with one or more aspects of the present invention;

FIG. 3 depicts the venue of FIG. 1, and illustrates a different result, using the notification provisioning process of FIG. 2, in accordance with one or more aspects of the present invention;

FIG. 4 depicts one embodiment of a computing system which may implement or incorporate notification provisioning based on location trends of group members within a venue, in accordance with one or more aspects of the present invention;

FIG. 5 depicts one embodiment of a cloud computing environment, which may facilitate implementing, or be used in association with one or more aspects of the present invention; and

FIG. 6 depicts an example of extraction model layers, which may facilitate implementing notification provisioning based, at least in part, on location trends of group members, in accordance with one or more aspects of the present invention.

### DETAILED DESCRIPTION

In general, a mobile device such as discussed herein is indicative of various types of devices, such as a wireless phone, a cellular phone, a laptop computer, a wireless multimedia device, a tablet, a wireless communication personal computer (PC), a PDA, etc. Any mobile device such as referenced herein may have memory for storing instructions and data, as well as hardware, software, and firmware, and combinations thereof. As is well known, the mobile devices can receive audio and/or video data packets over wireless networks, with notifications, such as advertisements, coupons, etc., being one example of data capable of being received by mobile devices.

Mobile devices are ubiquitous today, and facilitating new capabilities and uses continues to be of great interest as the technology develops. Improved advertising targeting is one example of an area of significant interest. For instance, location notifications may be beneficial to a shopper, giving the shopper deeper discounts than they might not have otherwise received. There are times, however, when notifications may be more of an annoyance, especially when a message doesn't relate directly to the individual receiving the message. This can be particularly problematic in a group situation, such as a family shopping together, to know which user might be interested in a particular offer. In such a case, a notification provisioning system would typically push an offer to each user's mobile device in the group, which can result in redundant messaging and messaging to uninterested group members.

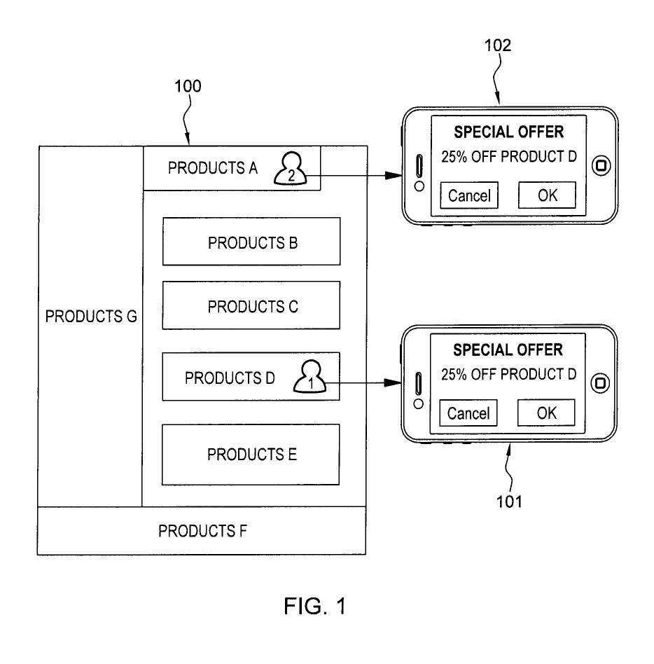

One embodiment of this is depicted in FIG. 1, where a venue 100 is illustrated. It is assumed that Users 1, 2 are member of a common group, such as a family. In this configuration, venue 100 includes multiple zones or regions of products A-G, with User 1 being in or near product D zone, and User 2 being in product A zone. In one possible notification provisioning approach, both users of the group might receive, via their respective mobile devices 101, 102, the same notification or advertisement which provides a discount to, for instance, a particular product within product zone D, within which User 1 is standing. By sending the notification to both members of the group, User 2 unnecessarily receives the notification, resulting in unnecessary data transfer, as well as potential annoyance to User 2 for an advertisement not relevant to where the user is currently located, or potentially of any interest to the user.

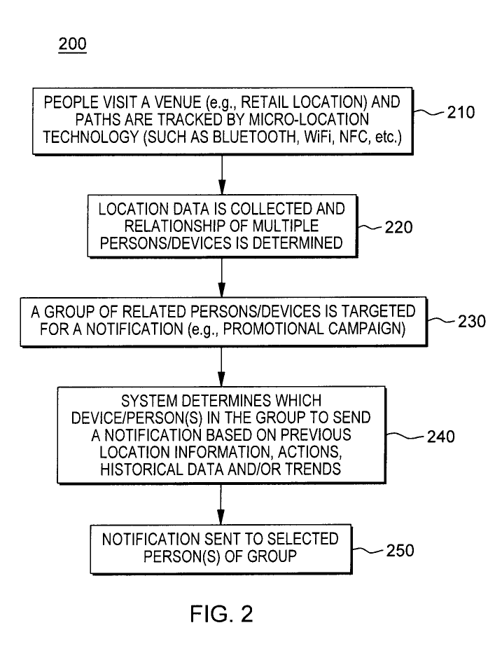

As a solution, disclosed herein is a notification provisioning approach based, at least in part, on location trends of individual group members. FIG. 2 depicts one embodiment of such a notification provisioning process 200, in accordance with one or more aspects of the present invention.

Referring to FIG. 2, people may visit a venue, such as a retail establishment, which is configured to monitor the customers' mobile devices to collect location and path data as the customers move through the venue 210.

By way of example, a “venue” may include any location that may be configured with, for instance, zones using short-distance wireless device location detection technology (e.g., Bluetooth′ Low Energy (BLE), or other hot spot beacons, triangulation, proximity, etc.), such as a sports arena, a store, shopping mall, food court, or other geographic area where people may gather and move among different locations within the area. A venue “zone” may include any area or region of a venue, such as a food court/cafeteria, a section of a store, a region of a shopping mall, or sports stadium, or other area/region that may be configured with short-distance wireless device location detection technology to detect movement among and within the respective areas or regions, as well as, for instance, the amount of time a mobile device user may dwell within a particular area or region. In this context, a venue “zone event” may refer to detection of a mobile device, and thereby the respective user carrying the mobile device, entering, moving within, dwelling at a location within, or leaving a particular venue zone.

Multiple different forms of zone events may be configured as granularly as appropriate for a particular zone, according to size and other factors relating to the particular zone (e.g., number and proximity of shelving or display units, etc.). The terms “dwell” and “dwell time” may refer to a user of a mobile device being detected as remaining in a particular location or zone for a particular duration of time. The term “dwell pattern” refers to coincident dwell times within venue zones of different mobile device users. The term “browsing patterns” may refer collectively to coincident movements within and among venue zones in combination with dwell patterns of different mobile device users as they journey through a venue.

Additionally, the term “related”, for instance, for inference of a group of users based on venue zone events, may refer to users being friends, acquaintances, family members, or having other relationship where the users know one another and/or develop a relationship during a course of coincident browsing patterns within a venue.

As illustrated in FIG. 2, process 200 may include, in one or more embodiments, inferring a relationship between multiple persons/devices 220, for instance, based on collected location data. In one or more implementations, multiple mobile devices within a venue may be tracked, with zone events occurring that represent relative movements and dwell times of the multiple mobile devices within the venue as users of the mobile devices move and dwell among the multiple configured zones of the venue. This information may then be used to infer a relationship between two or more of the users, for instance, responsive to a configured zone event threshold being satisfied by the tracked zone events that represents the relative movements and dwell times of the mobile devices of at least two users in the group.

For example, movement and dwell patterns may be analyzed for mobile device users as they enter, exit, and remain within one or more venues and/or zones, to determine how long different users stand (e.g., dwell/remain/stay) in certain areas of the venue, and the respective user's movement pattern within the venue, related to other users. This dwell and movement information of different users may then be used to determine a likelihood or probability of different users being related. It should be noted that the users may be provided with an opportunity to “opt in” to the location tracking technology described herein.

A number of preferences regarding when to “infer” a relationship between or among a group of different users may be established and configured. For example, a threshold zone entry time may be established, such that different users entering a zone within a configured time of each other may be inferred to be related (e.g., users entering a zone within ten (1) seconds of each other, one (1) minute of each other, etc.). If the users enter a zone within the configured threshold zone entry time, then the users may be inferred to be related.

Further, a threshold zone exit time may be established, such that different users exiting a zone within a configured time of each other, may be inferred to be related (e.g., users exiting a zone within ten (10) seconds of each other, one (1) minute of each other, etc.). If the users exit a zone within the configured threshold zone exit time, then the users may be inferred to be related.

Additionally, a threshold distance of movement over time may be established, such that different users remaining within a configured distance of each other as they move among/between and/or within zones, may be used to infer relationship between the users (e.g., users remaining within ten (10) feet of each other, within five (5) feet of each other, etc.). If the users remain within the configured threshold distance while moving, then the users may be inferred to be related.

Additionally, a threshold number of similar movements may be established, such as a number of time that different users move together among or within zones (e.g., one (1) time, two (2) times, three (3) times, etc.). If the users move together more than the configured threshold number of similar movements, then the users may be inferred to be related.

Further, a threshold shared dwell time may be established, such as an amount of time different users remain near one another within a zone (e.g., dwell for over five (5) minutes, ten (10) minutes, etc.). If the users dwell together more than the configured threshold of shared dwell time, then the users may be inferred to be related.

As another alternative, a threshold number of common zones at common times may be established, such that the number of times different users enter the same zones during the course of their respective time at a venue during the same time intervals (e.g., ten (10) or more total zones visited by each of different users within six (6) zone visits occurring at the same time, etc.). As such, if two users are shopping together, and also have their own browsing habits, but tend to meet each other throughout the shopping trip routinely more than the configured threshold number of common zones at common times, then the users may be inferred to be related.

Those skilled in the art will understand that many other possibilities exists for configuring threshold preferences as appropriate for a given venue. Any such possibilities are considered to be within the scope of the present subject matter.

Once one or more of the configured thresholds are met, then a group relationship between users may be documented and stored. The documented group relationship may be used to tailor promotions or other benefits to the respective users, as explained herein. The group relationship may also be shared within marketing teams for additional promotions/offers, based upon the inferred relationship.

Continuing with FIG. 2, an identified group of persons or users is targeted for a promotional campaign 230. The system then determines which user device in the group to send a particular promotion to, based on, for instance, accumulated data associated with the users of the group, including movement data of the mobile devices of the users in the group within the venue, currently and/or historically, as well as other current actions, previous actions, or other historic trends, or other data (such as shopping list data), as explained further below 240. The notification may then be sent to the selected user's mobile device so that the proper person in the group receives the notification 250.

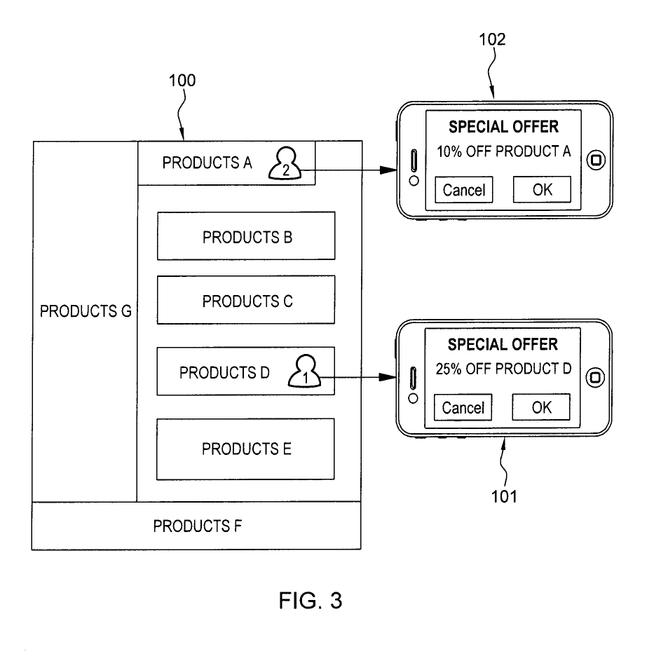

One embodiment of this is depicted in FIG. 3, where the venue of FIG. 1 is repeated, and only User 1 of the depicted group, which includes Users 1 and 2, receives on their mobile device 101 a notification or advertisement relating to product D, since User 1 is selected to be the person within the group that is to be targeted for the promotional campaign, as explained further below. As illustrated, User 2 may receive, in one or more embodiments, a different notification or advertisements on their mobile device 102, directed to a different product (in this example). Alternatively, mobile device 102 of User 2 may not currently receive any notification or advertisement.

By way of example, and as noted, a relationship may be identified or ascertained between two or more users of mobile devices within a venue, such as by a current inference using the above-noted approach, or by historical data indicative of a prior-established relationship between users of the mobile devices. Once a group is identified, in one or more embodiments, the system tracks movement of the mobile devices of the group of users within the venue, and determines which mobile device of the mobile devices of the two or more users of the group to provide a notification to based, for instance, on accumulated data associated with the users of the group. The accumulated data may include, for instance, movement data of the mobile devices of the two or more users in the group within the venue. Further, in one or more implementations, the accumulated data may include dwell time information on the mobile devices within the venue, venue visit frequency of the mobile devices of the members of the group, time-related venue visit data of the mobile devices of the users in the group, historical venue purchase data associated with the mobile devices of the users in the group, any shopping list data available from one or more of the users in the group, historical product purchase data associated with the users' mobile devices, social activity related to products or venues associated with the users' mobile devices, demographic data on the users in the group, and/or household data on members of the group, or any other data available and relevant in the context of determining which mobile device to provide with a particular notification at a particular time.

By way of specific example, a supermarket may be outfitted with one or more micro-location technologies to understand how customers move within their venue between zones of the venue by tracking the customers' mobile devices. A couple shopping at the venue weekly for household needs will be inferred to be in a group, as explained above. In addition, on a weekly basis, one person in the group may routinely pick up household cleaning supplies, while another person in the group may pick out fruits and vegetables for the week. A system such as disclosed herein can track these trends based on movements and dwell times of the couple's mobile devices within the venue. In following weeks, as the couple shops at the venue, the system becomes aware that a new notification or promotion would be relevant to the couple for a particular cleaning item based, for instance, on historical purchase data and/or currently available shopping list data for the couple. The system evaluates historical trends of the members of the group to determine which member would be best suited to receive the promotion, while the couple was in the venue. The system recognizes that one user would be the best person to receive the notification if it relates to a cleaning supply, and the notification is pushed to that user's mobile device. This is a different approach from what is currently done today, where both members of the group would typically receive the same notification on their mobile devices. In subsequent visits, should less than all members of the group be present within the venue when a notification is to be sent, the notification could be sent to the mobile device of the next-most relevant member of the group.

Advantageously, the present subject matter allows for real-time ascertaining of a relationship between two or more users of mobile devices within a venue by, for instance, facilitating inference of the users as a group based upon venue zone events, such as described above. Once a relationship is inferred or otherwise established, the relationship may be retained so that in future visits to the venue, the relationship between the users of the mobile devices is already known. The inference based upon venue zone events may be performed in real-time to allow prompt identification of a group of mobile device users. For purposes of this description, real-time includes any time frame of sufficiently short duration so as to provide reasonable response time for information processing acceptable to a user of the subject matter described. For instance, the relationship may be ascertained while the mobile device users remain within the venue.

With a group relationship established, notification provisioning may be based, at least in part, on location trends of the group members. In one or more implementations, short-distance wireless device location detection technology, such as Bluetooth™, Wi-Fi, NFC, etc., may be employed within the venue, as described above. For instance, wireless device location detection technology may be positioned within and/or at boundaries of locations in a venue to define zones within the venue, for instance, to detect mobile device movement and dwell times near or within defined zones. With tracking of movement of the mobile devices within the venue, as well as referencing other accumulated data such as described herein, processing is able to best determine which mobile device of the mobile devices of two or more users of a group to send a notification to. For instance, if a notification is a coupon relating to a particular product, and one user of a group is standing before the product or is within the aisle within which the product is located, then a notification may be sent to that individual, particularly where the historical data, or available shopping list data, indicates that the user is most likely to take advantage of the notification.

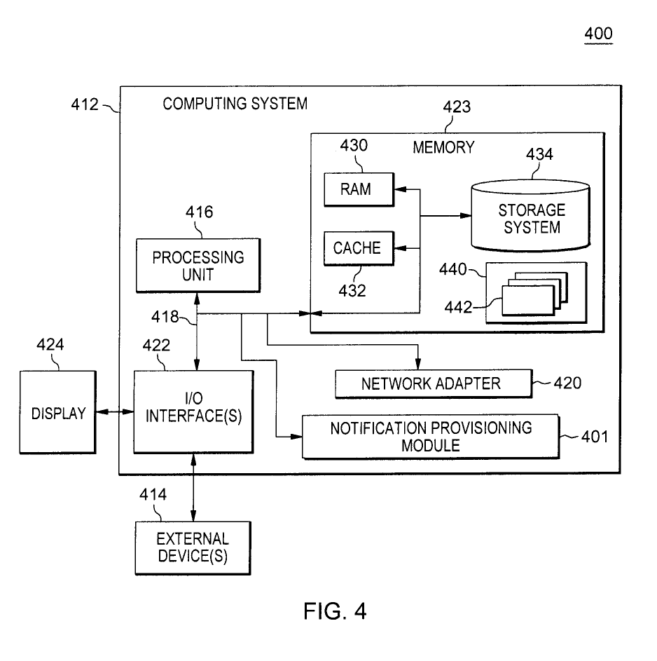

Exemplary embodiments of a computing environment to implement one or more aspects of the present invention are described below with reference to FIGS. 4-6.

By way of further example, FIG. 4 depicts one embodiment of a computing environment 400, which includes a computing system 412. Examples of well-known computing systems, environments, and/or configurations that may be suitable for use with computer system 412 include, but are not limited to, a wireless computer, a handheld or laptop computer or device, a mobile phone, a programmable consumer electronic device, a tablet, a personal digital assistant (PDA), and the like.

Computing system 412 may be described in the general context of computer system-executable instructions, such as program modules, being executed by a computer system. Generally, program modules may include routines, programs, objects, components, logic, data structures, and so on that perform particular tasks or implement particular abstract data types.

As depicted in FIG. 4, computing system 412, is shown in the form of a general-purpose computing device. The components of computing system 412 may include, but are not limited to, one or more processors or processing units 416, a system memory 423, and a bus 418 that couples various system components including system memory 423 to processor 416.

In one embodiment, processor 416 may be based on the z/Architecture® offered by International Business Machines Corporation, or other architectures offered by International Business Machines Corporation or other companies. z/Architecture® is a registered trademark of International Business Machines Corporation, Armonk, N.Y., USA. One embodiment of the z/Architecture® is described in “z/Architecture® Principles of Operation,” IBM Publication No. SA22-7832-10, March 2015, which is hereby incorporated herein by reference in its entirety.

In other examples, it may be based on other architectures, such as the Power Architecture offered by International Business Machines Corporation. One embodiment of the Power Architecture is described in “Power ISA™ Version 2.07B,” International Business Machines Corporation, Apr. 9, 2015, which is hereby incorporated herein by reference in its entirety. POWER ARCHITECTURE is a registered trademark of International Business Machines Corporation, Armonk, N.Y., USA. Other names used herein may be registered trademarks, trademarks, or product names of International Business Machines Corporation or other companies.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing system 412 may include a variety of computer system readable media. Such media may be any available media that is accessible by computing system 412, and it includes both volatile and non-volatile media, removable and non-removable media.

System memory 423 can include computer system readable media in the form of volatile memory, such as random access memory (RAM) 430 and/or cache memory 432. Computing system 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media could be provided. In such instances, each can be connected to bus 418 by one or more data media interfaces. As described below, memory 423 may include at least one program product having a set (e.g., at least one) of program modules that are configured to carry out the functions of embodiments of the invention.

Program/utility 440, having a set (at least one) of program modules 442, may be stored in memory 432 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Alternatively, a separate, notification provisioning processing system, module, logic, etc., 401 may be provided within computing environment 412.

Computing system 412 may also communicate with one or more external devices 414 such as a keyboard, a pointing device, a display 424, etc.; one or more devices that enable a user to interact with computing system 412; and/or any devices (e.g., network card, modem, etc.) that enable computing system 412 to communicate with one or more other computing devices. Such communication can occur via Input/Output (I/O) interfaces 422. Still yet, computing system 412 can communicate with one or more networks such as a local area network (LAN), a general wide area network (WAN), and/or a public network (e.g., the Internet) via network adapter 420. As depicted, network adapter 420 communicates with the other components of computing system, 412, via bus 418. It should be understood that although not shown, other hardware and/or software components could be used in conjunction with computing system 412. Examples, include, but are not limited to: microcode, device drivers, redundant processing units, external disk drive arrays, RAID systems, tape drives, and data archival storage systems, etc.

One or more aspects may relate to or use cloud computing.

It is understood in advance that although this disclosure includes a detailed description on cloud computing, implementation of certain teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

A cloud computing node may include a computer system/server, such as the one depicted in FIG. 4. Computer system/server 412 of FIG. 4 may be practiced in distributed cloud computing environments where tasks are performed by remote processing devices that are linked through a communications network. In a distributed cloud computing environment, program modules may be located in both local and remote computer system storage media including memory storage devices. Computer system/server 612 is capable of being implemented and/or performing any of the functionality set forth hereinabove.

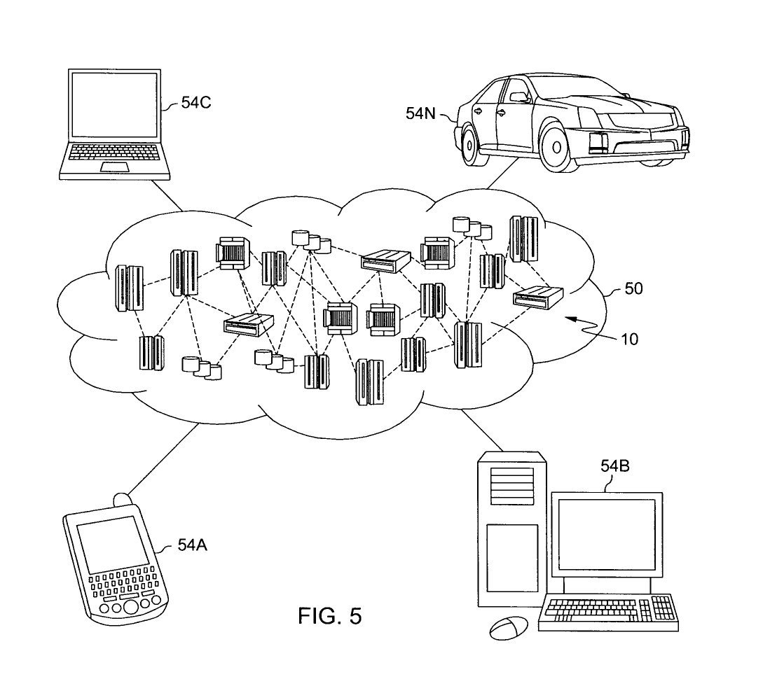

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

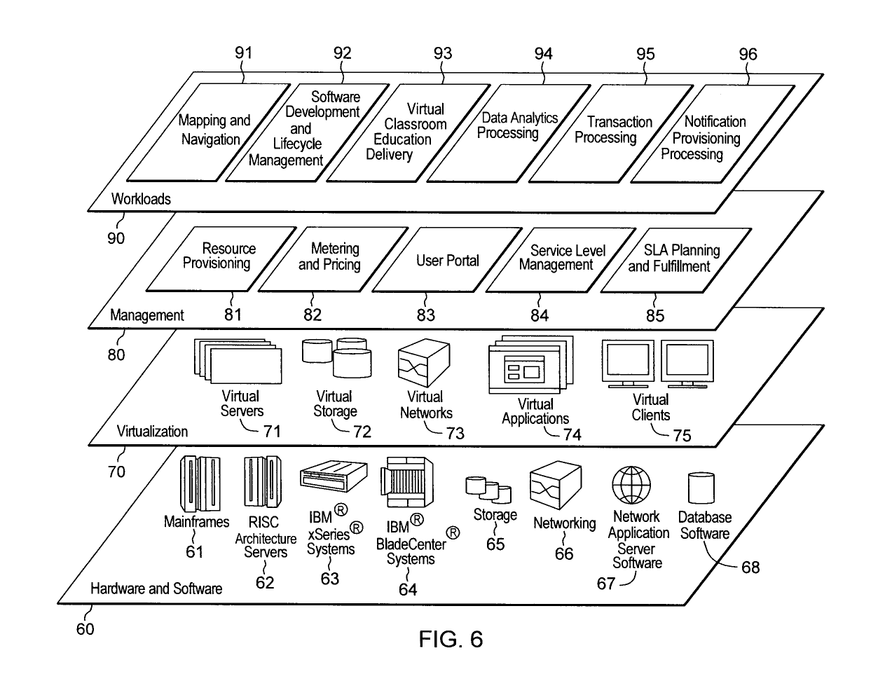

Referring to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and notification provisioning based on location trends of group member processing 96.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A computer-implemented method comprising:
identifying a group relationship between respective users of mobile devices within a venue;
tracking movement of the mobile devices of the users in the group within the venue; and
determining which mobile device of the mobile devices of the users in the group to send a notification to based, at least in part, on accumulated data associated with the users in the group, the accumulated data including movement data of the mobile devices of the users in the group within the venue.

2. The computer-implemented method of claim 1, wherein the notification is related to a particular zone of multiple zones within the venue, and the determining comprises determining which mobile device of the mobile devices of the users in the group at least one of dwells the longest within the particular zone, historically purchases more products from the particular zone, or frequents the particular zone the most.

3. The computer-implemented method of claim 1, further comprising, based on the determining, sending the notification to at least one mobile device of the mobile devices of the users in the group without sending the notification to at least one other mobile device of the users in the group.

4. The computer-implemented method of claim 1, wherein the accumulated data further includes data from the group consisting of:
venue visit frequency of the users' mobile devices;
time-related venue visit data of the users' mobile devices;
historical venue purchase data associated with the users' mobile devices;
historical product purchase data associated with the users' mobile devices;
social activity related to products or venues associated with the users' mobile devices;
demographic data for the respective users in the group; and
household data for the users in the group.

5. The computer-implemented method of claim 1, wherein the accumulated data comprises historical data on the movements and dwell times of the mobile devices of the users in the group within the venue during one or more prior visits of the users to the venue.

6. The computer-implemented method of claim 1, wherein the notification comprises a promotion specific to the venue.

7. The computer-implemented method of claim 1, wherein the determining occurs dynamically while the mobile devices of the users in the group are within the venue.

8. The computer-implemented method of claim 1, wherein the identifying comprises:
tracking within the venue movements and dwell times of multiple mobile devices within zones of the venue, as users of the respective multiple mobile devices move and dwell among and within the zones of the venue; and
inferring, by a processor, the group relationship between at least two users of the mobile devices based, at least in part, on the movements and dwell times of the mobile devices of the at least two users within the zones of the venue.

9. The computer-implemented method of claim 8, wherein the notification comprises a promotion specific to a zone of the multiple zones of the venue, and the accumulated data includes movements and dwell times of the mobile devices of the users in the group relative to that zone of the venue.

10. A system comprising:
a memory; and
a processing unit communicatively coupled to the memory, wherein the system performs a method comprising:
identifying in a group relationship between respective users of mobile devices within a venue;
tracking movement of the mobile devices of the users in the group within the venue; and
determining which mobile device of the mobile devices of the users in the group to send a notification to based, at least in part, on accumulated data associated with users in the group, the accumulated data including movement data of the mobile devices of the users in the group within the venue.

11. The system of claim 10, wherein the notification is related to a particular zone of multiple zones within the venue, and the determining comprises determining which mobile device of the mobile devices of the users in the group at least one of dwells the longest within the particular zone, historically purchases more products from the particular zone, or frequents the particular zone the most.

12. The system of claim 10, further comprising, based on the determining, sending the notification to at least one mobile device of the mobile devices of the users in the group without sending the notification to at least one other mobile device of the users in the group.

13. The system of claim 10, wherein the accumulated data further includes data from the group consisting of:
venue visit frequency of the users' mobile devices;
time-related venue visit data of the users' mobile devices;
historical venue purchase data associated with the users' mobile devices;
historical product purchase data associated with the users' mobile devices;
social activity related to products or venues associated with the users' mobile devices;
demographic data for the respective users in the group; and
household data for the users in the group.

14. The system of claim 10, wherein the accumulated data comprises historical data on the movements and dwell times of the mobile devices of the users in the group within the venue during one or more prior visits of the users to the venue.

15. The system of claim 10, wherein the notification comprises a promotion specific to the venue.

16. The system of claim 10, wherein the determining occurs dynamically while the mobile devices of the users in the group are within the venue.

17. The system of claim 10, wherein the identifying comprises:
tracking within the venue movements and dwell times of multiple mobile devices within zones of the venue, as users of the respective multiple mobile devices move and dwell among and within the zones of the venue; and
inferring, by a processor, the group relationship between at least two users of the mobile devices based, at least in part, on the movements and dwell times of the mobile devices of the at least two users within the zones of the venue.

18. The system of claim 17, wherein the notification comprises a promotion specific to a zone of the multiple zones of the venue, and the accumulated data includes movements and dwell times of the mobile devices of the users in the group relative to that zone of the venue.

19. A computer program product for determining which mobile device of a group of users to send a notification to, the computer program product comprising:
a computer readable storage medium having computer readable program code embodied therewith, the computer readable program code being executable by a processor to perform a method comprising:
identifying a group relationship between respective users of mobile devices within a venue;
tracking movement of the mobile devices of the users in the group within the venue; and
determining which mobile device of the mobile devices of the users in the group to send a notification to based, at least in part, on accumulated data associated with the users in the group, the accumulated data including movement data of the mobile devices of the users in the group within the venue.

20. The computer program product of claim 19, wherein the notification is related to a particular zone of multiple zones within the venue, and the determining comprises determining which mobile device of the mobile devices of the users in the group at least one of dwells the longest within the particular zone, historically purchases more products from the particular zone, or frequents the particular zone the most.
